(19) United States
(12) Patent Application Publication
(10) Pub. No.: US 2020/0036116 A1
(43) Pub. Date: Jan. 30, 2020

(54) CONNECTOR FOR PRINTED CIRCUIT BOARDS

(71) Applicant: SAURO S.R.L., Villafranca Padovana (IT)

(72) Inventors: Santino FAVERO, Padova (IT); Raffaele BORELLA, Abano Terme (IT)

(73) Assignee: SAURO S.R.L., Villafranca Padovana (IT)

(21) Appl. No.: 16/484,271

(22) PCT Filed: Feb. 8, 2018
(86) PCT No.: PCT/EP2018/053192

§ 371 Date: Aug. 7, 2019

(30) Foreign Application Priority Data
Feb. 14, 2017 (IT) 102017000015793

(51) Int. Cl. H01R 12/51; H01R 12/71

(52) U.S. Cl. CPC H01R 12/515; H01R 12/716

(57) ABSTRACT

A connector for printed circuit boards, comprising an enclosure made of insulating material with at least one cavity that can be accessed from the outside in order to accommodate at least one electrical cable and means for the connection of the electrical cable to the board.

The present invention relates to a connector for printed circuit boards.

Electrical connectors and terminal strips are known which allow to electrically connect printed circuit boards, also known as PCBs, to electrical cables in order to supply power to the devices that are present on the circuit itself.

Among the various types of connector, those with a screw tightening system are known.

These connectors are constituted typically by an enclosure made of insulating material with a plurality of cavities that can be accessed from the outside so that each accommodates an electrical cable. The enclosure is also provided with openings through which the connection to the connector elements of the printed circuit board is created.

At right angles to each cavity there is a screw which, when screwed toward the inside of the enclosure, presses the inserted electrical cable against a component that carries the electrical connection to the connector elements of the board.

These connectors, despite being widespread and allowing wiring of cables with a cross-section up to 1.5 mm², have a significant drawback, which is due to the vertical space occupation, which is greater than 11 mm.

With technological progress, the trend is to miniaturize electrical devices and render them more compact, but currently commercially available connectors set a limit to this miniaturization.

The aim of the present invention is to provide a connector for printed circuit boards that is capable of improving the background art in one or more of the aspects indicated above.

Within this aim, an object of the invention is to propose a connector that has smaller dimensions than those currently commercially available.

Another object of the invention is to propose a connector by virtue of which to reduce the overall space occupation of the printed circuit boards on which the connector is installed.

Furthermore, an object of the present invention is to overcome the limitations of the background art in a manner that is alternative to any existing solutions.

A still further object of the invention is to provide a connector that is highly reliable, relatively easy to provide and at competitive costs.

This aim, as well as these and other objects which will become better apparent hereinafter, are achieved by a connector according to claim 1, optionally provided with one or more of the characteristics of the dependent claims.

Further characteristics and advantages of the invention will become better apparent from the description of a preferred but not exclusive embodiment of the connector according to the invention, illustrated by way of nonlimiting example in the accompanying drawings, wherein:

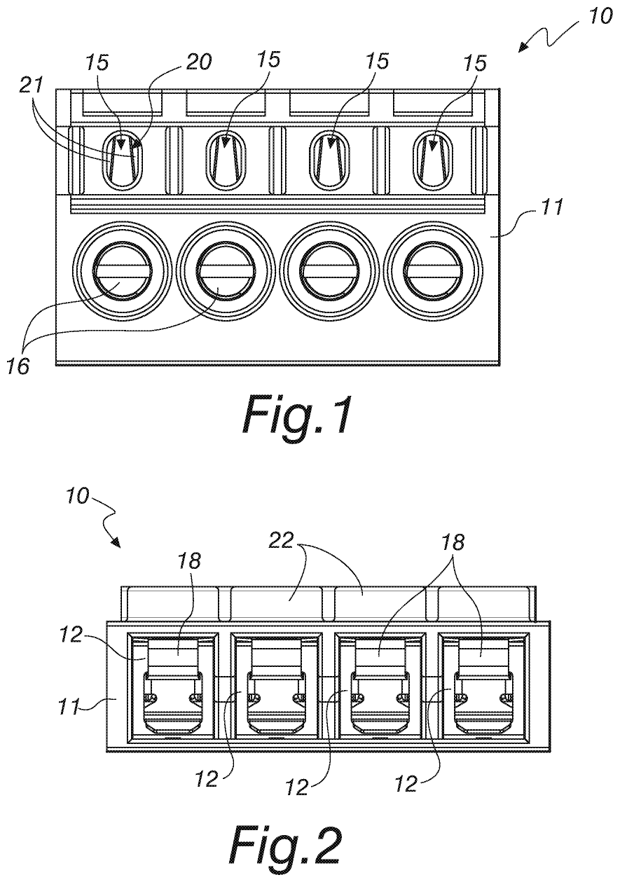

FIG. 1 is a top view of the connector according to the invention;

FIG. 2 is a side view of the connector according to the invention;

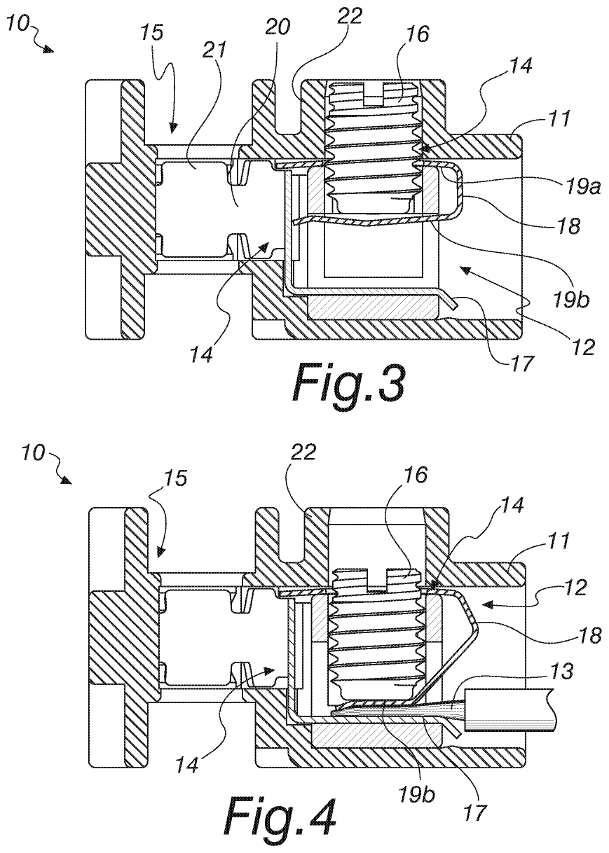

FIG. 3 is a cross-sectional view of the connector according to the invention in an inactive configuration;

FIG. 4 is a cross-sectional view of the connector according to the invention, similar to FIG. 3, in the active configuration.

With reference to the cited figures, the connector according to the invention, designated generally by the reference numeral 10, comprises an enclosure 11 made of insulating material with at least one cavity 12 that can be accessed from the outside in order to accommodate at least one electrical cable 13 and means 14 for connecting the electrical cable 13 to a printed circuit board.

The enclosure 11 is preferably made of plastic material.

In the illustrated example, the connector has a configuration that comprises four identical units arranged side by side, for connection to four respective connector elements of the board and to four corresponding electrical cables 13. It is to be understood that their number can vary as a function of the specific requirements.

The enclosure 11 is made of plastic material and is monolithic, with a configuration which therefore comprises four cavities 12, which allow the insertion of four corresponding electrical cables 13. Each one of the cavities 12 is adapted to accommodate an electrical cable 13.

The cavities 12 are clearly visible and indicated in FIG. 2 and in the cross-sectional views of FIGS. 3 and 4.

The enclosure 11 is also provided with openings 15 through which, in a known manner, the connection to the connector elements of the printed circuit board is created. These connector elements normally protrude from the board and therefore can be inserted each in one of said openings 15. These openings are visible and are indicated in the top view of FIG. 1 and in the cross-sectional views of FIGS. 3 and 4.

The openings 15 are equal in number to the cavities 12.

The connection means 14 advantageously comprise at least one grub screw 16, one for each cavity 12, which is adapted to press, by means of its tightening in the enclosure 11, the strands of the electrical cable 13 against an element 17, made of conducting material, for electrical connection to the connector elements of the board.

The grub screw 16 is screwed toward the inside of the enclosure 11 at right angles to a respective cavity 12, in order to press the electrical cable 13 against the electrical connection element 17.

The number of grub screws 16 is equal to the number of cavities 12, each one cooperating to lock a respective electrical cable 13.

The use of the grub screw 16 allows to reduce the dimensions of the enclosure 11, in particular of its portion indicated in FIGS. 2 to 4 by the reference numeral 22, since it is not necessary to provide for the containment of the head of the screw.

The enclosure 11 in fact advantageously has a thickness, measured in the direction of insertion of the grub screw 16, of less than 11 mm.

In particular, the enclosure 11 has a thickness, measured in the direction of insertion of the grub screw 16, that is equal to 7.9 mm.

The connector 10 comprises, accommodated in the cavity 12, a strand protection lamina 18, which is interposed between the tip of the grub screw 16 and the electrical cable 13.

In particular, the strand protection lamina 18 is bent into a C-shape and is made of elastically deformable material, with a hole provided on one of two opposite faces 19a thereof for the passage of the grub screw 16 so as to reach and push the other opposite face 19b toward the electrical connection element 17 during tightening.

FIGS. 3 and 4 are cross-sectional views of the connector 10 according to the invention respectively in an inactive configuration and in an active configuration, the latter corresponding to an arrangement of the strand protection lamina 18 with the face 19b lowered toward the electrical connection element 17 following the tightening of the grub screw 16.

In the same cross-sectional figures, it is evident that the electrical connection element 17 is constituted by an L-shaped lamina, with one face designed for contact with the electrical cable 13 and another face for connection to a female connector element 20, made of electrically conducting material, the latter being designed for mating with a corresponding male connector element of the board.

Obviously, for each cavity 12 there is a grub screw 16, a strand protection lamina 18, an electrical connection element 17 and a female connector element 20.

The female connector elements 20 are also visible in FIG. 1. They are provided with wings 21 designed to retain the male connector elements that protrude from the board.

The operation of the connector according to the invention is as follows.

Following the arrangement of the connector on the printed circuit board, with the mating of the connector elements, the grub screws 16 are tightened inside the enclosure 11 and toward the board.

At each unit of the connector 10, the movement of the grub screw 16 toward the electrical connection element 17 causes an elastic deformation of the strand protection lamina 18, which is moved into contact with the strands of the electrical cable 13 until they are pressed against the lamina of the electrical connection element 17. The latter and the female connector element 20 create, in a known manner, the electrical connection between the electrical cable 13 and the connector element of the board.

The fact that the connector 10 comprises a grub screw produces a space occupation in terms of thickness for the enclosure 11 that is lower than the one required for the tightening of a screw with a head.

This solution allows to provide a connector with a height equal to 7.9 mm.

In practice it has been found that the invention achieves the intended aim and objects, providing a connector that has smaller dimensions than those currently commercially available, also allowing a significant reduction in the overall space occupation of the printed circuit boards on which it is installed.

The invention thus conceived is susceptible of numerous modifications and variations, all of which are within the scope of the appended claims; all the details may furthermore be replaced with other technically equivalent elements.

In practice, the materials used, so long as they are compatible with the specific use, as well as the contingent shapes and dimensions, may be any according to the requirements and the state of the art.

The disclosures in Italian Patent Application No. 102017000015793 (UA2017A000924) from which this application claims priority are incorporated herein by reference.

1-6. (canceled)

7. A connector for printed circuit boards, comprising an enclosure made of insulating material with at least one cavity that can be accessed from the outside in order to accommodate at least one electrical cable and means for the connection of said electrical cable to said board, wherein said connection means comprise a grub screw which is adapted to press, by tightening it in said enclosure, strands of said electrical cable against an electrical connection element, made of conducting material, for electrical connection to the connector elements of said board.

8. The connector according to claim 7, wherein said enclosure has a thickness, measured in a direction of insertion of said grub screw, of less than 11 mm.

9. The connector according to claim 7, wherein said enclosure has a thickness, measured in a direction of insertion of said grub screw, equal to 7.9 mm.

10. The connector according to claim 7, further comprising, accommodated in said at least one cavity, a strand protection lamina that is interposed between a tip of said grub screw and said electrical cable in the connection to said board.

11. The connector according to claim 10, wherein said strand protection lamina is bent into a C-shape and is made of elastically deformable material, with a hole provided in one of two opposite faces thereof for the passage of said grub screw so as to reach and push the other opposite face toward said electrical connection element.

12. The connector according to claim 7, wherein said electrical connection element is constituted by an L-shaped lamina, with one face preset for contact with said electrical cable and another face for connection to a female connector, said female connector being preset for mating with a respective male connector of said board.
